(19) United States
(12) Patent Application Publication
(10) Pub. No.: US 2008/0062130 A1
(43) Pub. Date: Mar. 13, 2008

(54) MOUSE HAVING HOT KEY FOR INTERNET SEARCHING

(75) Inventor: Chih-Hung Lin, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/624,036

(22) Filed: Jan. 17, 2007

(30) Foreign Application Priority Data
Sep. 8, 2006 (TW) 095133176

(51) Int. Cl. G09G 5/08

(52) U.S. Cl. 345/163

(57) ABSTRACT

A mouse having a hot key is used for performing an internet searching operation. The mouse is electrically connected to a computer system, which is linked to a preset search website including a search box. The mouse includes a hot key and a hot key processing program. The hot key is activated to generate a depressing signal and a release signal. The hot key processing program is executed to be linked to the search website and implement the internet searching operation, wherein at least a search keyword marked by a user is copied in response to the depressing signal, and the computer system is linked to the preset search website and the marked search keyword is pasted into the search box in response to the release signal, thereby implementing the internet searching operation.

### FIELD OF THE INVENTION

The present invention relates to a mouse, and more particularly to a mouse having a hot key for internet searching.

### BACKGROUND OF THE INVENTION

Search engines have been widely used to find desired information on the Internet. For example, Google (http://www.google.com) and Yahoo (http://www.yahoo.com) are common search engines for internet searching. In addition to the function of searching desired information, some websites (e.g. http://www.dictionary.com and http://tw.dictionary.yahoo.com) also provide the translating functions.

Generally, the process of performing internet searching includes the following steps. Firstly, a web page including a search engine (e.g. Google) is linked by operating a mouse or inputting a website address. Then, a search keyword is inputted into the search box of the search engine. After the “Enter” icon shown on the search engine is hit or the “Enter” key of the keyboard is clicked, a list of web pages containing the search keyword are obtained.

For most users, it is troublesome by inputting the search keyword via the keyboard. In accordance with a common approach, the search keyword is copied and then pasted to the search box of the search engine. The process of performing internet searching by copying the search keyword includes the following steps. Firstly, a search keyword is marked by a mouse, and the “Copy” icon which is provided by an application program is hit so as to copy the search keyword. Alternatively, a composite key, e.g. “Ctrl+C”, is clicked via the keyboard to copy the search keyword. Then, a web page including a search engine (e.g. Google) is linked by operating a mouse or inputting a website address. Then, the search keyword is pasted into the search box of the search engine by executing a “Paste” instruction or clicking a composite key (e.g. “Ctrl+C”) via the keyboard. After the “Enter” icon shown on the search engine is hit or the “Enter” key of the keyboard is clicked, a list of web pages containing the search keyword are obtained.

Since the above two processes of performing internet searching need to perform three or four steps by the mouse and the keyboard, these processes are not user-friendly.

In views of the above-described disadvantages of the prior art, the applicant keeps on carving unflaggingly to develop a process of performing internet searching according to the present invention through wholehearted experience and research.

### SUMMARY OF THE INVENTION

It is an object of the present invention to provide a mouse including a hot key and a hot key processing program for performing an internet searching operation.

In accordance with an aspect of the present invention, there is provided a mouse having a hot key for performing an internet searching operation. The mouse is electrically connected to a computer system, which is linked to a preset search website including a search box. The mouse includes a hot key and a hot key processing program. The hot key is activated to generate a depressing signal and a release signal. The hot key processing program is executed to be linked to the search website and implement the internet searching operation, wherein at least a search keyword marked by a user is copied in response to the depressing signal, and the computer system is linked to the preset search website and the marked search keyword is pasted into the search box in response to the release signal, thereby implementing the internet searching operation.

Preferably, the information related to the preset search website is built-in the mouse.

In accordance with another aspect of the present invention, there is provided a process of performing an internet searching operation. The process comprising steps of issuing a copy instruction to a computer to copy a search keyword in response to a first triggering signal, and issuing a linking instruction, a pasting instruction and a start search instruction to the computer in response to a second triggering signal, thereby implementing the internet searching operation.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a mouse to be used for performing internet searching according to a preferred embodiment of the present invention;

FIGS. 2A, 2B and 2C schematically illustrate the contents shown on the monitor by the process of performing internet searching; and

FIG. 3 is a flowchart illustrating the process of performing internet searching.

### DETAILED DESCRIPTION OF THE PREFERRED EMBODIMENT

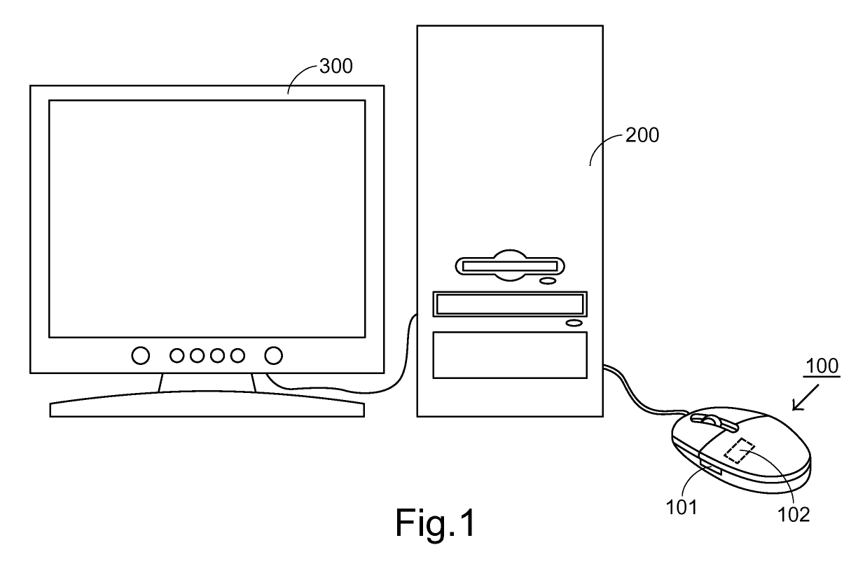

Referring to FIG. 1, a schematic view of a mouse to be used for performing internet searching is illustrated. As shown in FIG. 1, the mouse 100 is linked to a host computer 200, which is also electrically connected to a monitor 300. The mouse 100 includes a hot key 101 and a hot key processing program 102. In some embodiments, the hot key 101 is mounted on a sidewall of the mouse 100. Conventionally, the left-side control function key and the right-side control function key of a general computer mouse are clicked by a first finger and a middle finger, respectively. For increasing operating convenience, the hot key 101 may be clicked by the user's thumb. It is noted that, however, those skilled in the art will readily observe that numerous modifications and alterations of the locations of the hot key 101 may be made while retaining the teachings of the invention. In other words, the hot key 101 may be disposed on other locations of the mouse 100.

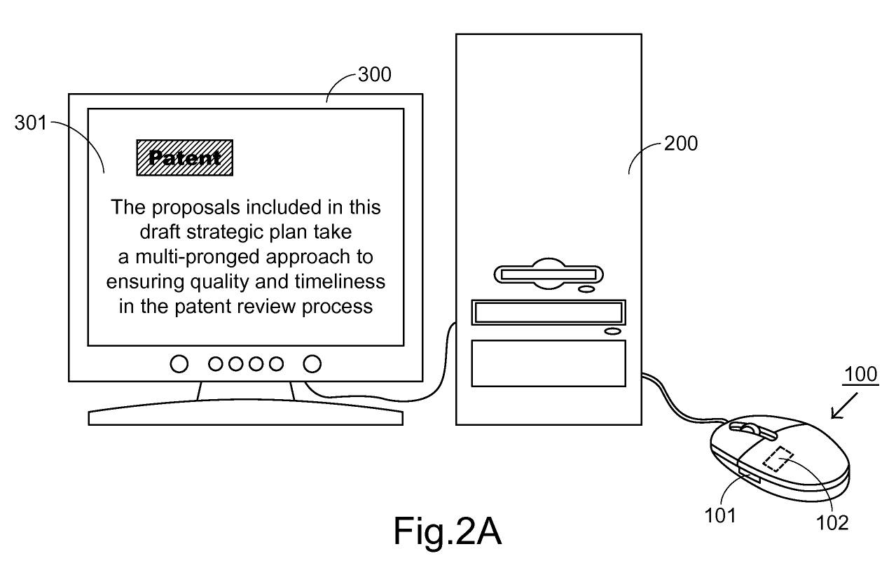

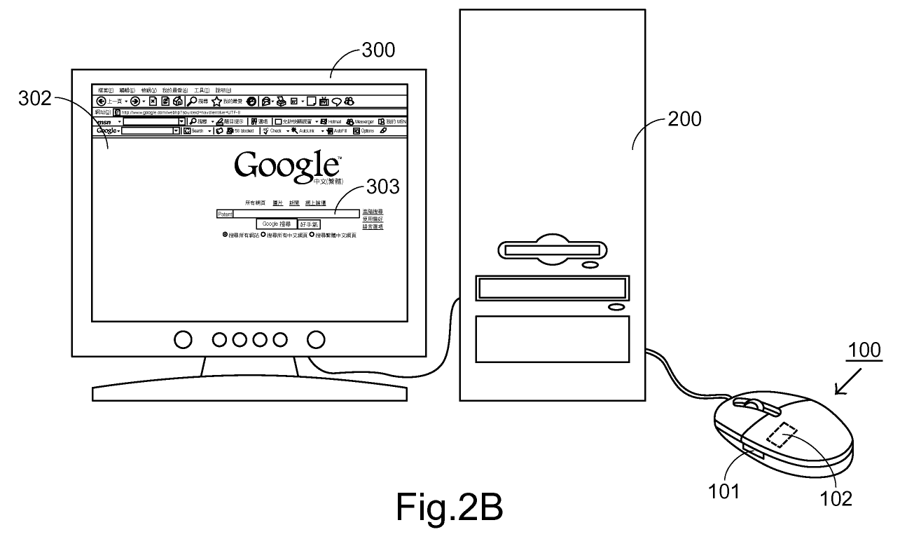

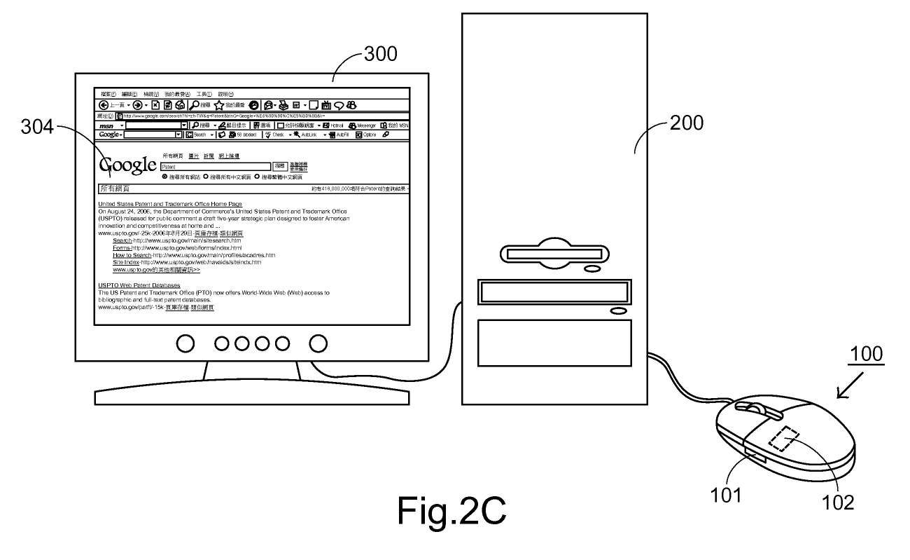

Referring to FIGS. 2A and 2B, the contents shown on the monitor by the process of performing internet searching according to a preferred embodiment of the present invention are illustrated.

As shown in FIG. 2A, a document 301 (e.g. a word document or an excel document) is displayed on the monitor 300. In a case that a search keyword “Patent” contained in the document 301 is selected for performing internet searching, the hot key 101 of the mouse 100 is depressed while marking the keyword “Patent” by the mouse 100.

After the hot key 101 is released, the host computer 200 will be linked to a specific website 302, e.g. Google (http://www.google.com). Meanwhile, the marked keyword “Patent” will be pasted into the search box 303 of the website 302 and a start search instruction is executed to perform internet searching. The above procedures are identical to the operation of clicking the “Google search” key shown on the website or the operation of clicking the “Enter” key of the keyboard. In addition to the search engine Google, the host computer 200 can be linked to other websites (e.g. http://www.dictionary.com and http://tw.dictionary.yahoo.com) for providing the translating functions.

Afterwards, the searching results 304 obtained by using the search keyword “Patent” are obtained as shown in FIG. 2C.

In the above embodiment, by using the mouse 100 having the hot key 101 for performing internet searching, the hot key 101 is depressed to mark the search keyword and then released to implement the internet searching operation. In other words, a single step of depressing/releasing the hot key 101 is sufficient for implementing the internet searching operation.

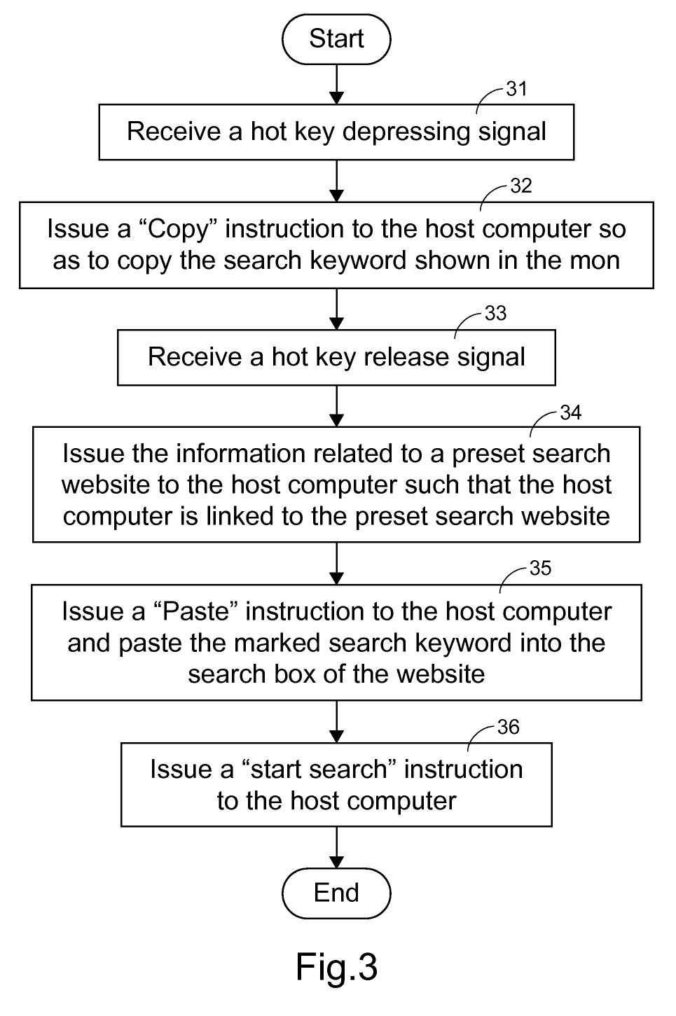

Hereinafter, the operation of the hot key processing program 102 will be illustrated as follows with reference to FIG. 3.

Firstly, in Step 31, a depressing signal is received by the hot key processing program 102 when the user depresses the hot key 101. In response to the depressing signal, a “Copy” instruction is issued to the host computer 200 so as to copy the search keyword shown in the monitor 300 (Step 32). Then, a release signal is received by the hot key processing program 102 when the user releases the hot key 101 (Step 33). In response to the release signal, the information related to a preset search website (e.g. http://www.google.com) is issued to the host computer 200 such that the host computer 200 is linked to the preset search website (Step 34). Then, a “Paste” instruction is issued to the host computer 200 and the marked search keyword “Patent” is pasted into the search box 303 of the website 302 (Step 35). Afterwards, a start search instruction is issued to the host computer 200 to perform internet searching (Step 36), thereby obtaining the searching results 304 as shown in FIG. 2C.

Since the mouse 100 of the present invention includes the hot key 101, the hot key processing program 102 and the information related to the preset search website, no driver is required to be installed in the computer in order to implement the internet searching operation.

As previously described, the conventional processes of performing internet searching needs three or four steps. In contrast, a single step of depressing/releasing the hot key 101 is sufficient for implementing the internet searching operation according to the present invention. As a consequence, the process of the present invention is more efficient and user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse having a hot key for performing an internet searching operation, said mouse being electrically connected to a computer system, which is linked to a preset search website including a search box, said mouse including:
a hot key activated to generate a depressing signal and a release signal; and
a hot key processing program executed to be linked to said search website and implement said internet searching operation, wherein at least a search keyword marked by a user is copied in response to said depressing signal, and said computer system is linked to said preset search website and said marked search keyword is pasted into said search box in response to said release signal, thereby implementing said internet searching operation.

2. The mouse according to claim 1 wherein the information related to said preset search website is built-in said mouse.

3. A process of performing an internet searching operation comprising steps of:
issuing a copy instruction to a computer to copy a search keyword in response to a first triggering signal; and
issuing a linking instruction, a pasting instruction and a start search instruction to said computer in response to a second triggering signal, thereby implementing said internet searching operation.
